(19) United States
(12) Patent Application Publication
(10) Pub. No.: US 2025/0210897 A1
(43) Pub. Date: Jun. 26, 2025

(54) POWER CONNECTOR WITH SIMPLIFIED ASSEMBLY STRUCTURE

(71) Applicant: JESS-LINK PRODUCTS CO., LTD., New Taipei City (TW)

(72) Inventors: Hsu-Feng CHANG, New Taipei City (TW); Hu LIU, New Taipei City (TW)

(21) Appl. No.: 18/642,861

(22) Filed: Apr. 23, 2024

(30) Foreign Application Priority Data
Dec. 22, 2023 (CN) 202311791172.0

(51) Int. Cl. H01R 13/04; H01R 12/73; H01R 13/10; H01R 13/502

(52) U.S. Cl. CPC H01R 13/04; H01R 13/10; H01R 13/502; H01R 12/73

(57) ABSTRACT

A power connector with a simplified assembly structure is provided. The power connector includes an insulating housing and a terminal assembly. The insulating housing includes two openings at one end and a socket at the other end. The socket communicates with the two openings. A partition is extended and connected between an inner left wall and an inner right wall of each opening, and multiple pairs of protruding ribs protrude from the partition to create two separated spaces in each opening. The terminal assembly includes a positive terminal and a negative terminal, each with two conductive plates and multiple pairs of clamping elastic pieces extending from one end of the two conductive plates and bending inward. The clamping elastic pieces are inserted in the socket, and the conductive plates are respectively positioned in the separated spaces and contacted by the protruding ribs.

### BACKGROUND OF THE INVENTION

### Technical Field

The present disclosure relates to a power connector, and particularly to a power connector with a simplified assembly structure.

### Description of Related Art

Power connectors are conductive electronic components used to connect electrical circuits. They are widely used in various electrical circuits, serving to connect or disconnect circuits, or to provide power connections between different circuit systems and equipment.

However, as connectors strive for simplified assembly steps and stable structures, designing terminals that may be easily inserted into an insulating body to position the terminals, as well as improving the efficiency of the power connector's capacity to carry current, becomes a focal point in the research and development of power connector manufacturers.

In view of this, the inventor has targeted the above-mentioned existing technology, devoted to research combined with theoretical application, and strived to solve the aforementioned problems, which has become the goal of the inventor's development.

### SUMMARY OF THE INVENTION

The present disclosure provides a power connector with a simplified assembly structure. The power connector utilizes separated spaces formed between multiple pairs of protruding ribs and both an inner front wall and an inner rear wall. Conductive plates inserted in the separated spaces are contacted by the protruding ribs. One end of the conductive plates extends to form multiple pairs of clamping elastic pieces bending inward. This design facilitates easy assembly and enhances the efficiency of the power connector in carrying electrical current.

In embodiments of the present disclosure, a power connector with a simplified assembly structure is provided. The power connector includes: an insulating housing, wherein one end of the insulating housing is provided with two parallel openings on the left and the right, another end of the insulating housing is provided with a socket that communicates with the two openings, and an inner wall of each of the openings includes an inner left wall, an inner right wall, an inner front wall, and an inner rear wall, wherein a partition is extended and connected between the inner left wall and the inner right wall, multiple pairs of protruding ribs extend from the partition toward the inner front wall and the inner rear wall, and two separated spaces are established between the protruding ribs and both the inner front wall and the inner rear wall; and a terminal assembly including a positive terminal and a negative terminal, wherein the positive terminal and the negative terminal each include two conductive plates arranged corresponding to each other, multiple pairs of clamping elastic pieces extend from one end of the conductive plates and bent inward, each of the multiple pairs of the clamping elastic pieces is inserted in the socket, and the two conductive plates of each of the positive terminal and the negative terminal are inserted in the two separated spaces and abutted against by the multiple pairs of protruding ribs.

Based on the above, when the conductive plates of the power connector are slightly deformed or have large tolerances, they generate point friction with the protruding ribs in the separated spaces. This point friction is less than surface friction, allowing the positive and negative terminals to be smoothly installed in the openings. Once inserted, the positive and negative terminals are easily positioned within the insulating housing. This design makes the power connector easy to be assembled and simplifies the assembly process.

In light of the above, the power connector of the present disclosure employs multiple pairs of clamping elastic pieces connected to a card PCB, and the elastic pieces extends from a single conductive plate. This design enables the power connector to handle larger electrical currents to enhance the efficiency of the power connector in carrying electrical current.

### BRIEF DESCRIPTION OF THE DRAWINGS

FIG. 1 is an exploded perspective view of a power connector of the present disclosure.

FIG. 2 is a perspective assembly view of the power connector of the present disclosure.

FIG. 3 is a schematic cross-sectional view of the power connector of the present disclosure.

FIG. 4 is another schematic cross-sectional view of the power connector of the present disclosure.

FIG. 5 is a schematic view of a use state of the power connector of the present disclosure.

### DETAILED DESCRIPTION

Detailed descriptions and technical contents of the present disclosure are explained below in conjunction with the accompanying drawings. However, the accompanying drawings are for illustrative purposes only and are not intended to limit the scope of the present disclosure.

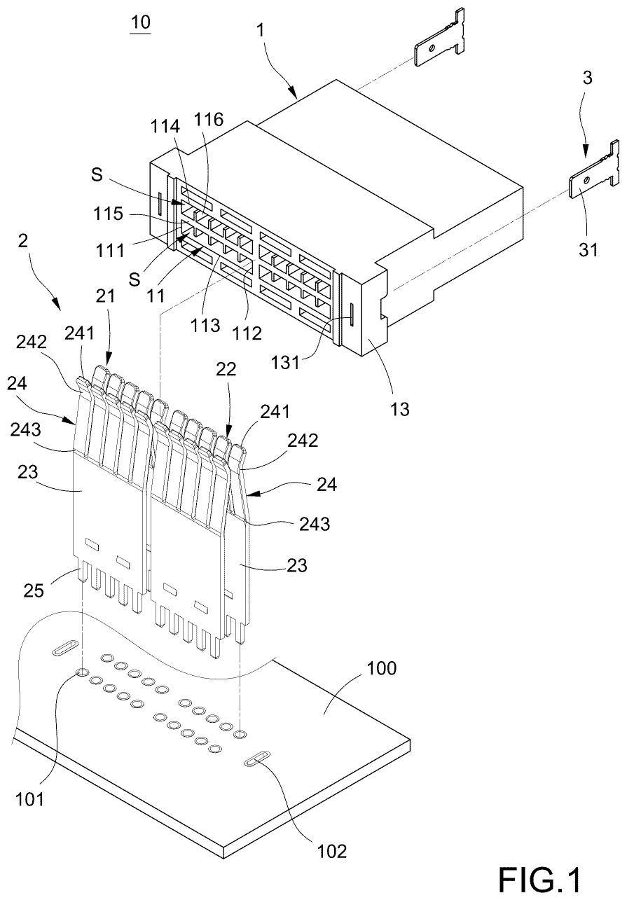

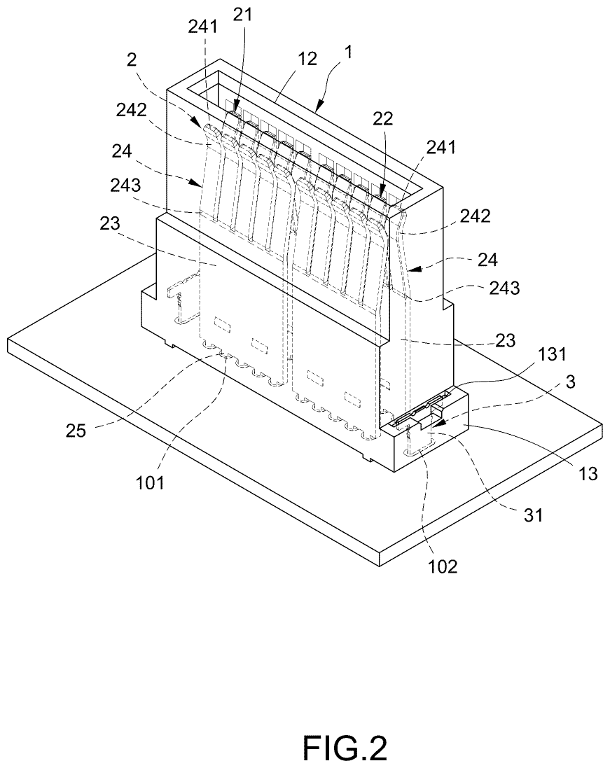

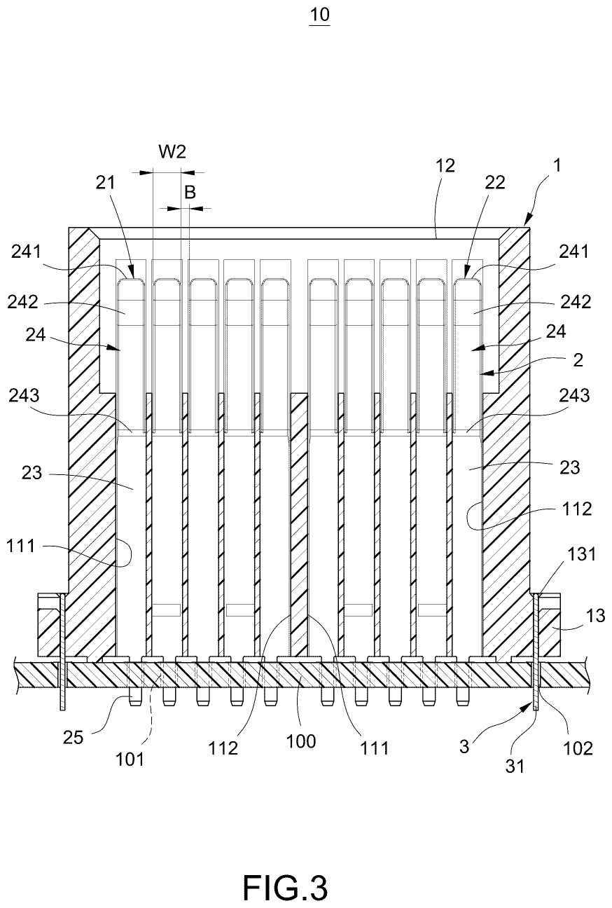

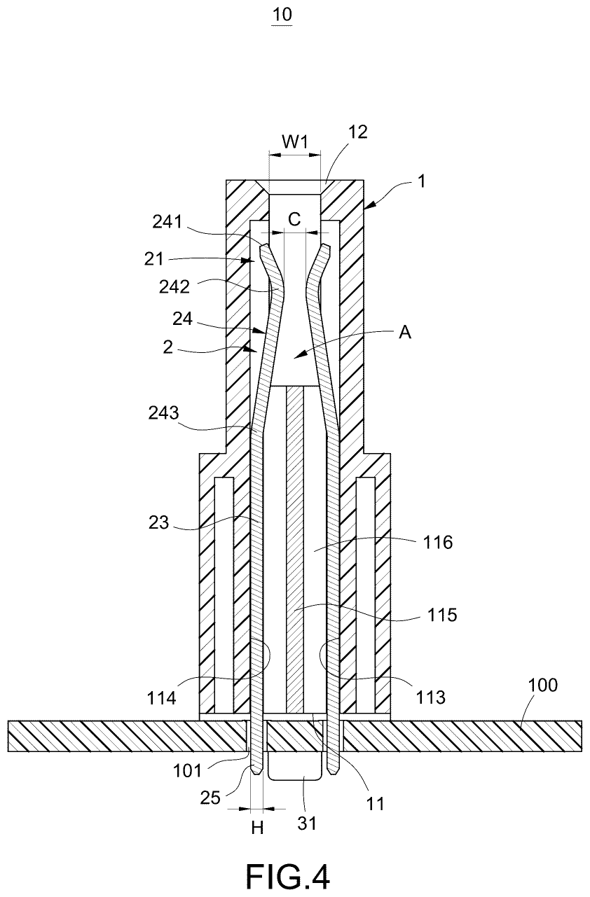

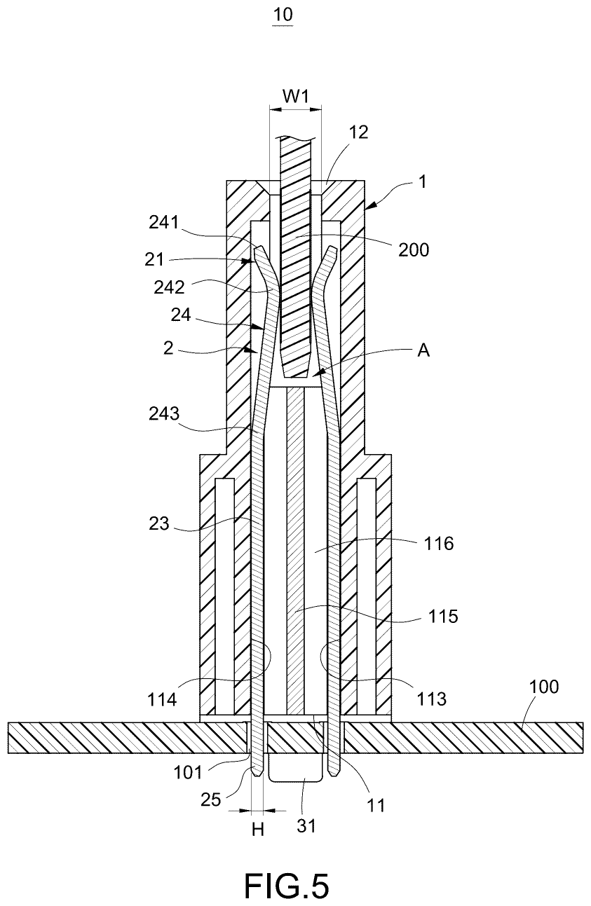

Please refer to FIGS. 1 to 5. The present disclosure provides a power connector with a simplified assembly structure. This power connector 10 is a card edge connector. The power connector 10 primarily includes an insulating housing 1 and a terminal assembly 2.

Please refer to FIGS. 1 to 5. One end of the insulating housing 1 is provided with two openings 11 defined parallelly on the left side and the right side, and another end of the insulating housing 1 is provided with a socket 12 that communicates with the two openings 11. An inner wall of each of the openings 11 includes an inner left wall 111, an inner right wall 112, an inner front wall 113, and an inner rear wall 114. A partition 115 is extended and connected between the inner left wall 111 and the inner right wall 112, multiple pairs of protruding ribs 116 are extended from the partition 115 toward the inner front wall 113 and the inner rear wall 114, and two separated spaces S are defined among the protruding ribs 116 and both the inner front wall 113 and the inner rear wall 114.

The insulating housing 1 is provided with two protrusions 13 extending from two sides of the insulating housing 1 and arranged at two ends of the two openings 11. Each of the protrusions 13 is provided with a T-shaped slot 131. A minimum width W1 of the socket 12 in the present embodiment is about 4.7 mm. The present disclosure is not limited in this regard.

Please refer to FIGS. 1 to 5. A terminal assembly 2 includes a positive terminal 21 and a negative terminal 22. The positive terminal 21 and the negative terminal 22 each includes two conductive plates 23 arranged corresponding to each other and multiple pairs of clamping elastic pieces 24 extending from one end of the conductive plates 23 and bent inward. Each of the multiple pairs of clamping elastic pieces 24 is inserted in the socket 12. Each pair of the conductive plates 23 is inserted in the two separated spaces and abutted against by the multiple pairs of the protruding ribs 116.

Detailed description is as follows. Each pair of the clamping elastic pieces includes two terminal ends 241 and two bend points 242 formed between the two conductive plates 23 and the two terminal ends 241. A gap A is defined between the clamping elastic pieces 24 of each pair, the gap A of the clamping elastic pieces 24 of each pair is gradually decreased from the two conductive plates 23 to the two bend points 242 and is gradually increased from the two bend points 242 to the two terminal ends 241.

A card PCB 200 may be inserted in the insulating housing 1 from the socket 12 and clamped by the two bend points 242 of each of the multiple pairs of the clamping elastic pieces 24, and is electrically connected to the positive terminal 21 and the negative terminal 22.

Each of the bend points 242 has a curvature radius of about 3 mm. Each clamping elastic piece 24 includes a bending point at a junction with the respective corresponding conductive plate 23. Each of the bending points 243 has a curvature radius of about 2.5 mm.

In each of the openings 11, the number of the pairs of the protruding ribs 116 is one less than the number of the pairs of the clamping elastic pieces 24 of the positive terminal 21 and the negative terminal 22. In each of the openings 11, the multiple pairs of the protruding ribs 116 are arranged corresponding to spacings B between the pairs of the clamping elastic pieces 24 of the positive terminal 21 and the negative terminal 22.

Furthermore, a thickness H of both the positive terminal 21 and the negative terminal 22 is between about 0.6 mm to about 0.7 mm. A width W2 of both the positive terminal 21 and the negative terminal 22 is between about 1.75 mm to about 1.85 mm. A distance C between each pair of the clamping elastic pieces is about 1.15 mm.

Moreover, each of the positive terminal 21 and the negative terminal 22 is provided with multiple pairs of conductive pins extending from another end of the two conductive plates. The multiple pairs of the conductive pins 25 are plugged into conductive contact holes 101 of the circuit board 100. The arrangement ensures that the power connector 10 is not only installed on the circuit board 100 but also electrically connected to the circuit board 100.

As shown in FIGS. 1 to 5, the power connector 10 includes two T-shaped fixing plates 3. Each of the T-shaped fixing plates 3 is inserted into the respective corresponding T-shaped slot 131. The T-shaped fixing plate 3 includes two fixing pieces 31 exposed from the protrusions 13 and arranged on two sides of the multiple pairs of the conductive pins 25. The fixing pieces 31 are inserted into two fixing holes 102 on the circuit board 100, ensuring that the power connector 10 is securely mounted on the circuit board 100.

As shown in FIGS. 1 to 5, the power connector 10 in use employs each opening 11 with a partition 115 spanning between the inner left wall 111 and the inner right wall 112. From the partition 115, multiple pairs of protruding ribs 116 extend toward the inner front wall 113 and inner rear wall 114, creating two separated spaces S defined between the protruding ribs and both the inner front wall 113 and the inner rear wall 114. When the two conductive plates 23 are inserted in the separated spaces S, the two conductive plates 23 are contacted by the multiple pairs of the protruding ribs 116.

In the related-art power connector, an insulating housing has an I-shaped slot for insertion of terminals. In this case, if the terminals are slightly deformed or have large tolerances, they would normally create friction against inner walls of the I-shaped slot, making it difficult to install the terminals in the I-shaped slot. In comparison, in the power connector 10 of this disclosure, when the conductive plates 23 are slightly deformed or have large tolerances, the conductive plates create point friction with the protruding ribs 116 inside the separated spaces S. This point friction is less than surface friction, allowing the positive terminal 21 and the negative terminal 22 to be smoothly installed in the openings 11. This achieves the positioning of the positive and negative terminals 21 and 22 in the insulating housing 1 as soon as they are pushed into the openings 11, making the power connector 10 easy to assemble.

Moreover, when each pair of the conductive plates 23 is inserted in the two separated spaces S, the conductive plates 23 are contacted and separated by the multiple pairs of protruding ribs 116, preventing short-circuiting between the positive terminal 21 and the negative terminal 22. This design gives the power connector 10 a stable structure.

Furthermore, the power connector 10 employs the multiple pairs of the clamping elastic pieces 24 to be connected with the card PCB 200. The multiple pairs of the clamping elastic pieces 24 and the multiple pairs of the conductive pins 25 extend from a single conductive plate 23, allowing the power connector 10 to handle larger currents, thus ensuring excellent current-carrying efficiency.

In summary, the power connector with the simplified assembly structure has not been seen in similar products.

What is claimed is:

1. A power connector, comprising:
an insulating housing, comprising two openings defined parallelly on one thereof and a socket defined on another end thereof and communicating with the two openings, and an inner wall of each of the openings comprising an inner left wall, an inner right wall, an inner front wall, and an inner rear wall, wherein a partition is extended and connected between the inner left wall and the inner right wall, multiple pairs of protruding ribs are extended from the partition toward the inner front wall and the inner rear wall, and two separated spaces are defined among the protruding ribs, the inner front wall and the inner rear wall; and
a terminal assembly, comprising a positive terminal and a negative terminal, wherein the positive terminal and the negative terminal each comprises two conductive plates arranged corresponding to each other, multiple pairs of clamping elastic pieces extended from one end of the conductive plates and bent inward, each of the multiple pairs of the clamping elastic pieces is inserted in the socket, and the two conductive plates of each of the positive terminal and the negative terminal are inserted in the two separated spaces and abutted against by the multiple pairs of protruding ribs.

2. The power connector according to claim 1, wherein each pair of the clamping elastic pieces comprises two terminal ends and two bend points disposed between the two conductive plates and the two terminal ends, a gap is defined between each pair of the clamping elastic pieces, and the gap of each pair of the clamping elastic pieces is gradually decreased from the two conductive plates to the two bend points and is gradually increased from the two bend points to the two terminal ends.

3. The power connector according to claim 2, wherein each of the bend points is provided with a curvature radius of about 3 mm, a bending point is defined at a junction between each clamping elastic piece the conductive plate, and each of the bending points is provided with a curvature radius of about 2.5 mm.

4. The power connector according to claim 2, wherein a distance between the two bend points of each pair of the clamping elastic pieces is about 1.15 mm.

5. The power connector according to claim 1, wherein in each of the openings, a number of the pairs of the protruding ribs is one less than a number of the pairs of the clamping elastic pieces of the positive terminal and the negative terminal, and the multiple pairs of the protruding ribs are arranged corresponding to spacings between the pairs of the clamping elastic pieces of the positive terminal and the negative terminal.

6. The power connector according to claim 5, wherein a spacing between two pairs of the clamping elastic pieces adjacent to each other is between about 0.45 mm to about 0.65 mm.

7. The power connector according to claim 1, wherein a thickness of the positive terminal and a thickness of the negative terminal are respectively between about 0.6 mm to about 0.7 mm, and a width of the positive terminal and a width of the negative terminal are respectively between about 1.75 mm to about 1.85 mm.

8. The power connector according to claim 1, wherein a minimum width of the socket is about 4.7 mm.

9. The power connector according to claim 1, wherein each of the positive terminal and the negative terminal comprises multiple pairs of conductive pins extending from another end of the two conductive plates.

10. The power connector according to claim 9, further comprising two T-shaped fixing plates, wherein the insulating housing comprises two protrusions extended from two sides thereof and positioned at two ends of the two openings, each of the protrusions comprises a T-shaped slot, each of the T-shaped fixing plates is inserted in each of the T-shaped slots, and the two T-shaped fixing plates respectively comprise two fixing pieces exposed from the two protrusions and arranged on two sides of the multiple pairs of the conductive pins.
